(19) United States
(12) Patent Application Publication
(10) Pub. No.: US 2022/0400870 A1
(43) Pub. Date: Dec. 22, 2022

(54) DUAL-SIDED GEL LAYER AND USE THEREOF IN BODY SUPPORT ARTICLE

(71) Applicant: Elements Group LLC, Mesquite, TX (US)

(72) Inventor: Josh Micklos, Mesquite, TX (US)

(73) Assignee: Elements Group LLC, Mesquite, TX (US)

(21) Appl. No.: 17/845,901

(22) Filed: Jun. 21, 2022

Related U.S. Application Data
(60) Provisional application No. 63/213,135, filed on Jun. 21, 2021.

(51) Int. Cl. A47C 27/14

(52) U.S. Cl. CPC A47C 27/144; A47C 27/148

(57) ABSTRACT

A gel layer, comprising a first gel lattice having a first geometric shape. The first geometric shape has a first gel lattice height; a first gel lattice width; and a first gel lattice length. The first gel lattice comprises a plurality of first gel segments, wherein the first gel segments define a plurality of first gaps. The first gel lattice has a first firmness.

### BACKGROUND OF THE INVENTION

### Field of the Invention

Generally, the present disclosure relates to a dual-sided gel material, and its use in body support articles, such as mattresses, mattress toppers, cushions, pillows, and the like.

### Description of the Related Art

Foam body support articles, e.g., pillows, cushions, mattress toppers, and mattresses, such as viscoelastic or so-called “memory foam” mattresses, provide desirably high levels of firmness and support for many users. However, mattresses comprising only viscoelastic foam may lack sufficient support for some users. Also, mattresses comprising only one particular type of foam may lack desired levels of support for certain regions of a user's body. Further, foam mattresses are often reputed to “sleep hot,” i.e., inadequately dissipate the user's body heat.

Attempts to resolve these issues include the use of mattress toppers, including toppers comprising gel bodies embedded in a suitable material and/or bonded to upper and/or lower fabric layers. However, existing gel toppers provide uniform support to all users of a mattress, and thus, if the partners sharing a mattress have different support preferences, one of the partners may be dissatisfied by a mattress topper providing support preferred by the other, or both partners may be dissatisfied if, in an effort to compromise, they select a mattress topper that is “neither fish nor fowl,” providing too little support for one and too much support for the other.

“Sleeping hot” is commonly addressed by the inclusion of phase change materials (PCMs) which absorb heat as part of a transition between their solid and liquid forms or between crystal structures thereof. However, once the phase change is complete, the material has little additional capacity to absorb heat from the user. Accordingly, the relief provided by PCMs is short-lived, generally lasting far less than 6-8 hours.

The present disclosure may address and/or at least reduce one or more of the problems identified above.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure, or to delineate the scope of the disclosure. Its sole purpose is to present some concepts in a simplified form as a prelude to the more detailed description that is discussed later.

In one embodiment, the present disclosure is directed to a gel layer comprising a first gel lattice having a first geometric shape. The first geometric shape has a first gel lattice height; a first gel lattice width; and a first gel lattice length. The first gel lattice comprises a plurality of first gel segments, wherein the first gel segments define a plurality of first gaps. The first gel lattice has a first firmness.

In another embodiment, the present disclosure is directed to a gel layer comprising a first gel lattice having a first geometric shape and a second geometric shape. The first geometric shape has a first gel lattice height; a first gel lattice width; and a first gel lattice length. The first gel lattice comprises a plurality of first gel segments, wherein the first gel segments define a plurality of first gaps. The first gel lattice has a first firmness. The second geometric shape has a second gel lattice height; a second gel lattice width; and a second gel lattice length. The second gel lattice comprises a plurality of second gel segments, wherein the second gel segments define a plurality of second gaps. The second gel lattice has a second firmness.

In another embodiment, the present disclosure is directed to a gel layer comprising a first gel lattice having a rectangular prism shape having a first gel lattice height, a first gel lattice width, and a first gel lattice length, wherein the first gel lattice height is no more than one-third of the shorter of the first gel lattice width and the first gel lattice length, the first gel lattice comprising a plurality of first gel segments each having a first segment height essentially equal to the first gel lattice height and a first segment thickness less than the first segment height, wherein the first gel segments define a plurality of first gaps, and the first gel lattice has a first firmness in a direction parallel to the first gel lattice height. The gel layer also comprises a second gel lattice having a rectangular prism shape having a second gel lattice height, a second gel lattice width, and a second gel lattice length, wherein the second gel lattice height is no more than one-third of the shorter of the second gel lattice width and the second gel lattice length, the second gel lattice comprising a plurality of second gel segments each having a second segment height essentially equal to the second gel lattice height and a second segment thickness less than the second segment height, wherein the second gel segments define a plurality of second gaps, and the second gel lattice has a second firmness in a direction parallel to the second gel lattice height.

The present disclosure may provide for body support articles, e.g., mattresses, mattress toppers, pillows, and cushions, with improved comfort for users reclining thereon, even if multiple users have different firmness preferences and/or if the user finds that conventional foam mattresses tend to sleep hot.

### BRIEF DESCRIPTION OF THE DRAWINGS

The disclosure may be understood by reference to the following description taken in conjunction with the accompanying drawings, in which like reference numerals identify like elements, and in which:

FIG. 1A illustrates a stylized top view of a gel layer, in accordance with embodiments herein.

FIG. 1B illustrates a stylized nearsighted side cross-sectional view of the gel layer of FIG. 1A along line A-A′, in accordance with embodiments herein.

FIG. 2 illustrates a stylized nearsighted side cross-sectional view of a gel layer comprising two gel lattices, in accordance with embodiments herein.

FIG. 3A illustrates a stylized top plan view of a first gel space, in accordance with embodiments herein.

FIG. 3B illustrates a stylized top plan view of a second gel space, in accordance with embodiments herein.

FIG. 3C illustrates a stylized top plan view of a third gel space, in accordance with embodiments herein.

FIG. 3D illustrates a stylized top plan view of a fourth gel space, in accordance with embodiments herein.

FIG. 3E illustrates a stylized top plan view of a fifth gel space, in accordance with embodiments herein.

FIG. 3F illustrates a stylized top plan view of a sixth gel space, in accordance with embodiments herein.

FIG. 3G illustrates a stylized top plan view of a seventh gel space, in accordance with embodiments herein.

FIG. 3H illustrates a stylized top plan view of an eighth gel space, in accordance with embodiments herein.

FIG. 3I illustrates a stylized top plan view of a ninth gel space, in accordance with embodiments herein.

FIG. 3J illustrates a stylized top plan view of a tenth gel space, in accordance with embodiments herein.

FIG. 3K illustrates a stylized top plan view of an eleventh gel space, in accordance with embodiments herein.

FIG. 3L illustrates a stylized top plan view of a rosette comprising six instances of the eleventh gel space of FIG. 3K, in accordance with embodiments herein.

FIG. 4 illustrates a stylized nearsighted side cross-sectional view of a body support article comprising a gel layer, in accordance with embodiments herein.

FIG. 5 illustrates a stylized nearsighted side cross-sectional view of a body support article comprising a gel layer comprising two gel lattices, in accordance with embodiments herein.

FIG. 6A illustrates a stylized top view of a body support article comprising two gel layers, one disposed on the left half of the body support article and the other disposed on the right half of the body support article, in accordance with embodiments herein.

FIG. 6B illustrates a stylized side view of a body support article comprising a gel layer, in accordance with embodiments herein.

6C illustrates a stylized side view of a body support article comprising a gel layer, in accordance with alternative embodiments herein.

FIG. 7 provides a flowchart of a method, in accordance with embodiments herein;

FIG. 8 conceptually depicts a manufacturing system, in accordance with embodiments herein.

FIG. 9 presents a substantially top view of a portion of a gel layer comprising the gel space of FIG. 3K, in accordance with embodiments herein.

FIG. 10 presents a substantially top view of a portion of a gel layer comprising the gel space of FIG. 3K in the rosette of FIG. 3L, in accordance with embodiments herein.

FIG. 11 presents a substantially top view in a first orientation of a portion of a gel layer comprising the gel space of FIG. 3J, in accordance with embodiments herein.

FIG. 12 presents a substantially top view in a second orientation of a portion of a gel layer comprising the gel space of FIG. 3J, in accordance with embodiments herein.

FIG. 13 presents a substantially top view in the first orientation of a portion of a gel layer comprising the gel space of FIG. 3J, in accordance with embodiments herein.

FIG. 14 presents a substantially top view of a gel layer comprising the gel space of FIG. 3K in the rosette of FIG. 3L, in accordance with embodiments herein.

FIG. 15 presents a substantially top view of a gel layer comprising an upper gel lattice comprising the gel space of FIG. 3K in the rosette of FIG. 3L and a lower gel lattice comprising the gel space of FIG. 3J, in accordance with embodiments herein.

FIG. 16 presents a substantially top view of a gel layer comprising an upper gel lattice comprising the gel space of FIG. 3J, in accordance with embodiments herein.

FIG. 17 presents a substantially top view of a gel layer comprising an upper gel lattice comprising the gel space of FIG. 3J and a lower gel lattice comprising the gel space of FIG. 3K in the rosette of FIG. 3L, in accordance with embodiments herein.

FIG. 18 presents a perspective view of a gel layer comprising an upper gel lattice comprising the gel space of FIG. 3J, in accordance with embodiments herein.

FIG. 19 presents a perspective view of a gel layer comprising an upper gel lattice comprising the gel space of FIG. 3J, in accordance with embodiments herein.

FIG. 20 presents a perspective view of a gel layer comprising an upper gel lattice comprising the gel space of FIG. 3J, in accordance with embodiments herein.

FIG. 21 presents substantially top views of portions of two gel layers, one gel layer comprising an upper gel lattice comprising the gel space of FIG. 3J and a lower gel lattice comprising the gel space of FIG. 3K in the rosette of FIG. 3L, and the other gel layer comprising an upper gel lattice comprising the gel space of FIG. 3K in the rosette of FIG. 3L and a lower gel lattice comprising the gel space of FIG. 3J, in accordance with embodiments herein.

FIG. 22 presents a perspective view of a body support article comprising a support layer and a gel layer, wherein the gel layer is positioned under a fabric overlayer, in accordance with embodiments herein.

For the avoidance of doubt, and in accordance with practice before the United States Patent and Trademark Office, none of the present figures are to scale.

While the subject matter disclosed herein is susceptible to various modifications and alternative forms, specific embodiments thereof have been shown by way of example in the drawings and are herein described in detail. It should be understood; however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### INCORPORATION BY REFERENCE

The following United States patents and published applications are hereby incorporated herein by reference.

U.S. Pat. Nos. 10,721,992; 9,775,403; 9,717,304; 9,320,317; 8,434,748; 7,138,079; 7,076,822; 6,865,759; 6,413,458; 6,026,527; 5,994,450; 5,881,409; 5,749,111; 5,626,657; 5,549,743; 5,421,874; 2018/0295941; 2018/0295934; 2015/0230549; 2014/0259748; and 2014/0259743.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are schematically depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments herein are directed to body support articles, and methods and systems for manufacturing such body support articles, wherein the body support articles have improved user experience, such as support for multiple users having different support preferences and/or improved comfort for users who tend to sleep hot. Body support articles include, but are not limited to, mattresses, pillows, mattress toppers, cushions, etc.

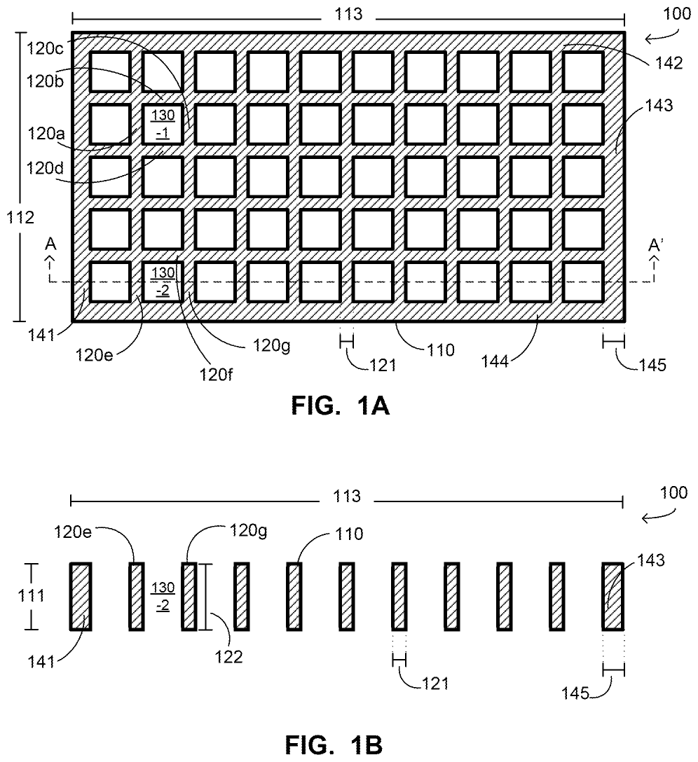

FIG. 1A illustrates a stylized top view of a gel layer 100, in accordance with embodiments herein. FIG. 1B illustrates a stylized nearsighted side cross-sectional view of the gel layer 100 along line A-A′. By “nearsighted” is meant that elements of the gel layer 100 disposed behind the line A-A′ are omitted, e.g., a first gel segment 120f, as will be discussed in more detail below.

The gel layer 100 comprises a first gel lattice 110 having a rectangular prism shape having a first gel lattice height 111, a first gel lattice width 112, and a first gel lattice length 113. The “width” and the “length” may be arbitrarily selected, each from an opposed pair of sides of the rectangular prism. Typically, and particularly for embodiments wherein the gel layer 100 is intended to top at least about half of a body support article, the width and height may be selected such that the first gel lattice width 112 is less than the first gel lattice length 113.

Regardless how the width and height are assigned, the first gel lattice height 111 is no more than one-third of the shorter of the first gel lattice width 112 and the first gel lattice length 113. In other words, the first gel lattice 110 is much shorter than it is long and wide.

In embodiments, the first gel lattice height 111 may be from about 0.25″ (0.64 cm) to about 2″ (5.08 cm).

“Gel” is a term well-known in the art. More information regarding gel formulations and manufacturing techniques can be found in patents and other literature incorporated herein by reference.

In one embodiment, the first gel lattice 110 may comprise the following components by weight: Styrene block copolymer 2-80%, plasticized oil 10-90%, thermoplastic polystyrene-polybutadiene-polystyrene block copolymer 5-80%, toner 0.03-3%.

In a further embodiment, the first gel lattice 110 may comprise an essential oil additive from 0.01%-5% by weight. In one embodiment, the essential oil component of the essential oil additive is selected from the group consisting of green tea oil, sweet orange oil, menthol oil, peppermint oil, cedarwood oil, lemon oil, eucalyptus oil, aromatic litsea/mountain pepper oil, clove oil, spearmint oil, rose oil, lemongrass oil, lavender oil, thyme oil, alfalfa oil, allspice oil, ambrette (seed) oil, angelica root oil, angelica seed oil, angelica stem oil, angostura (cusparia bark) oil, anise oil, asafetida-foetida oil, balm (lemon balm) oil, balsam of peru oil, basil oil, bay leaves oil, bay (myrcia oil) oil, bergamot (bergamot orange) oil, bitter almond oil, bois de rose oil, cacao oil, camomile (chamomile) flowers oil, cananga oil, capsicum oil, caraway oil, cardamom seed (cardamon) oil, carob bean oil, carrot oil, cascarilla bark oil, cassia bark oil, chinese oil, cassia bark oil, padang or batavia oil, cassia bark oil, saigon oil, celery seed oil, cherry oil, wild oil, bark oil, chervil oil, chicory oil, cinnamon bark oil, ceylon oil, cinnamon bark oil, chinese oil, cinnamon bark oil, saigon oil, cinnamon leaf oil, ceylon oil, cinnamon leaf oil, chinese oil, cinnamon leaf oil, saigon oil, citronella oil, citrus peels oil, clary (clary sage) oil, clover oil, coca (decocainized) oil, coffee oil, cola nut oil, coriander oil, cumin (cummin) oil, curacao orange peel (orange oil, bit oil, cusparia bark oil, dandelion oil, dandelion root oil, dog grass (quackgrass oil, triticum) oil, elder flowers oil, estragole (esdragol oil, esdragon oil, t oil, estragon (tarragon) oil, fennel oil, sweet oil, fenugreek-gr oil, galanga (galangal) oil, geranium oil, geranium oil, east indian oil, geranium oil, rose oil, ginger oil, grapefruit oil, guava oil, hickory bark oil, horehound (hoarhound) oil, hops oil, horsemint oil, hyssop oil, immortelle oil, jasmine oil, juniper (berries) oil, kola nut oil, laurel berries oil, laurel leaves oil, lavender oil, lavender oil, spike oil, lavandin oil, lemon(l.) burm. oil, lemon balm oil, lemongrass oil, lemon peel(l.) oil, lime oil, linden flowers oil, locust bean oil, oil, lupulin oil, mace oil, mandarin oil, marjoram oil, sweet oil, yerba mate oil, melissa (see balm) oil, menthol oil, menthyl acetate oil, molasses (extract) oil, mustard oil, naringin oil, neroli oil, bigarade oil, nutmeg oil, onion oil, orange oil, bitter oil, flowers oil, orange oil, bitter oil, peel oil, orange leaf(l.) oil, orange oil, sweet oil, orange oil, sweet oil, flowers oil, orange oil, sweet oil, peel oil, origanum oil, palmarosa oil, paprika oil, parsley (mi oil, pepper oil, black oil, pepper oil, white oil, peppermint oil, peruvian balsam oil, petitgrain oil, petitgrain lemon oil, petitgrain mandarin or tangerine oil, pimenta oil, pimenta leaf oil, pipsissewa leaves oil, pomegranate oil, prickly ash bark oil, rose absolute oil, rose (otto of roses oil, attar of roses) oil, rose buds oil, rose flowers oil, rose fruit (hips) oil, rose geranium oil, rose leaves oil, rosemary oil, saffron oil, sage oil, sage oil, greek oil, sage oil, spanish oil, st. john's bread oil, savory oil, summer oil, savory oil, winter oil, schinus molle oil, sloe berries (blackthorn berries) oil, spearmint oil, spike lavender oil, tamarind oil, tangerine oil, tarragon oil, tea oil, thyme oil, thyme oil, white oil, thyme oil, wild or creeping oil, tuberose oil, turmeric oil, vanilla oil, violet flowers oil, violet leaves oil, violet leaves absolute oil, wild cherry bark oil, ylang-ylang oil, and zedoary bark oil.

In one embodiment, the essential oil is green tea oil, which may be present at 0.3 wt %.

The first gel lattice 110 comprises a plurality of first gel segments, collectively and/or generically 120, with individual first gel segments 120a, 120b, 120c, 120d, 120e, 120f, and 120g specifically identified in FIG. 1A and FIG. 1B. The definition of “segments” is arbitrary, in that the first gel lattice 110 is essentially integral. Generally, each first gel segment 120 has a first segment height 122 essentially equal to the first gel lattice height 111, and a first segment thickness 121 less than the first segment height 122.

The first gel segments 120 define a plurality of first gaps, collectively and/or generically 130, with individual first gaps 130-1 and 130-2 specifically identified in FIG. 1A and FIG. 1B. In FIG. 1A and FIG. 1B, the first gap 130-1 is defined by first gel segments 120a, 120b, 120c, and 120d. The first gap 130-2 is defined by first gel segments 120e, 120f, and 120g, along with a perimeter segment 144 to be described later.

Accordingly, a “segment” may be considered as a portion of the first gel lattice 110 that separates any two adjacent first gaps 130. Each first gap 130 has a first size and a first shape. The shape is defined herein by reference to two-dimensional figures as seen from a top view. For example, the first gaps 130 depicted in FIG. 1A, e.g., first gaps 130-1 and 130-2 each have a square shape. The size of the first gaps 130 may also be varied, with “size” here referring to the lengths of the gel segments 120 defining each first gap 130 and the surface area of the shape.

The square shape of the first gaps 130 in FIG. 1A is merely exemplary. Any one or more of a wide range of shapes may be considered. In one embodiment, the first gaps 130 may each have a first size and a first shape selected from the group consisting of squares, rectangles, diamonds, parallelograms, other quadrilaterals, triangles, polygons with other than four sides, circles, ellipses, raindrops, and other curved shapes.

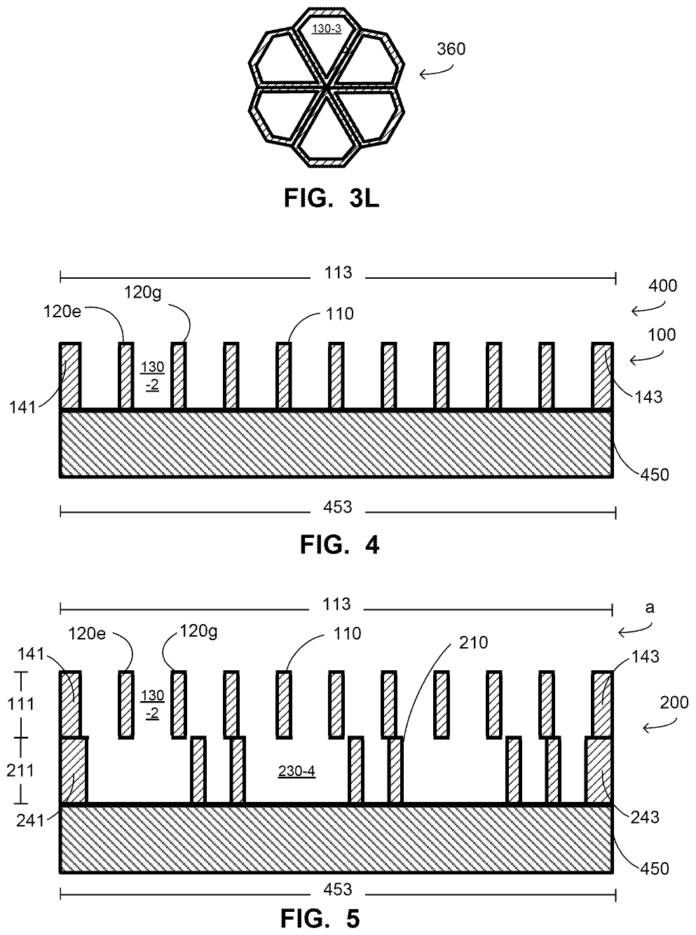

FIG. 3A-FIG. 3K show particular top views of individual first gaps 130 that may be used in the gel layer 100 or 200. In one embodiment, each first gap 130 has a shape in top view selected from the group consisting of squares, rectangles, diamonds, parallelograms, other quadrilaterals, triangles, polygons with other than four sides, circles, ellipses, raindrops, and other curved shapes. For example, in FIG. 3A, the first gap 130 has a square shape in top view, with the understanding the square is oriented such that all of the gel segments 120 are parallel to a side of the gel lattice. In FIG. 3B, the first gap 130 has a rectangular shape in top view. In FIG. 3C, the first gap 130 has a square shape in top view, with the understanding the square is oriented such that none of the gel segments 120 are parallel to any side of the gel lattice. In FIG. 3D, the first gap 130 has a parallelogram shape in top view. In FIG. 3E, the first gap 130 has a triangular shape in top view. In FIG. 3F, the first gap 130 has a hexagonal shape in top view. In FIG. 3G, the first gap 130 has a circular shape in top view. In FIG. 3H, the first gap 130 has an elliptical shape in top view. In FIG. 3I, the first gap 130 has a raindrop shape in top view.

In FIG. 3J, the gap 130 has a diamond shape in top view. By “diamond” herein is meant a quadrilateral defined by four gel segments 120, wherein each of the gel segments 120 has the same length. The four gel segments 120 define four corners, each with an interior vertex angle α or β, with vertex angles α being at a first pair of opposed corners and vertex angles β being at a second pair of opposed corners. Generally, α is less than 90° and β is more than 90°, with the proviso that α+β=180°. In one embodiment, α is from 45° to 85° and β is from 95° to 135°.

Though not to be bound by theory, we have observed that a first gel lattice 110 comprising diamond-shaped first gaps 130 tends to be plush, i.e., is relatively not firm. It also tends to have greater strength at the joints between first gel segments 120 than square-shaped gaps, i.e., first gel segments 120 are less likely to tear or otherwise suffer damage at joints when the first gaps 130 are diamond-shaped.

In FIG. 3K, the gap 130-3 has a convex pentagon shape that is neither equilateral nor equiangular. In the specific embodiment shown in FIG. 3K, the convex pentagon shape is defined by two consecutive first gel segments 324a, 324b, each having a length equal to a first length, and three consecutive first gel segments 325a, 325b, and 325c, each having a length equal to a second length less than the first length.

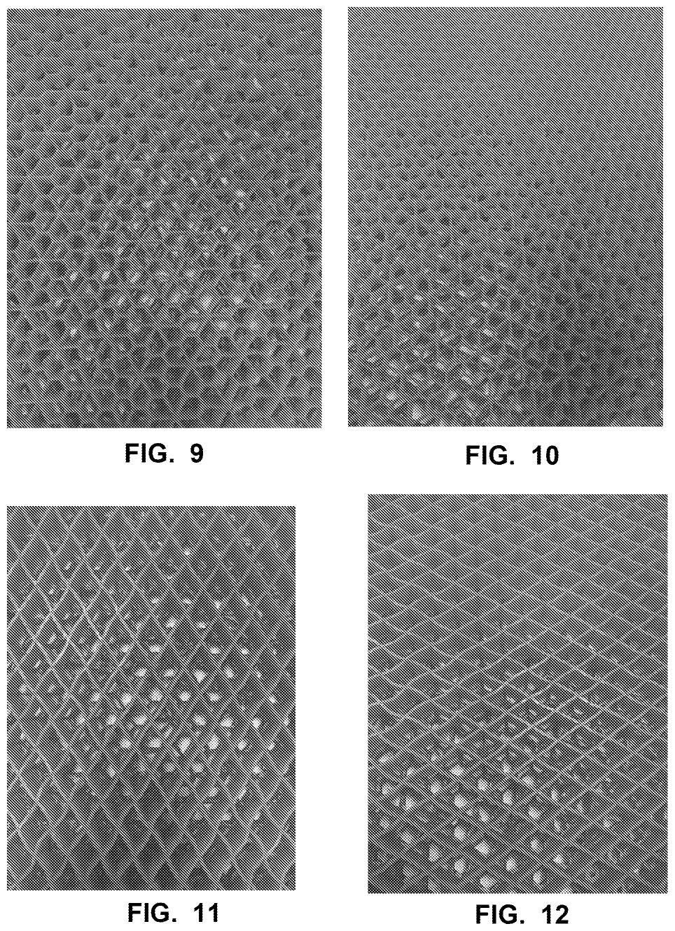

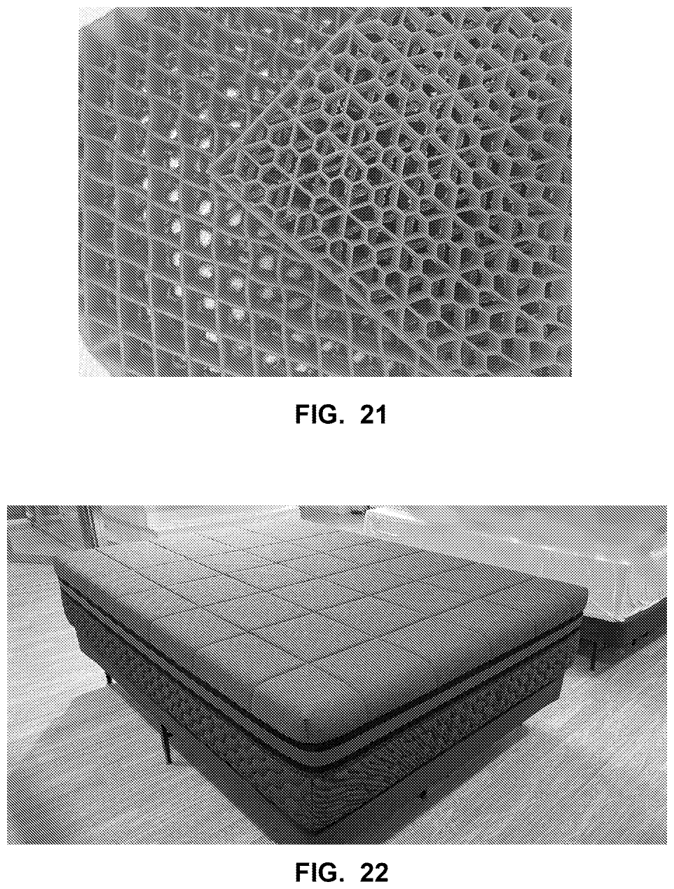

One property of interest of the convex pentagon shape that is neither equilateral nor equiangular is shown in FIG. 3L. In FIG. 3L, six of the convex pentagon shapes 130-3 form a rosette 360 with 6-fold rotational symmetry around a vertex of the two consecutive first gel segments having the first length. The precise values of the first length and the second length may be selected such that the rosette 360 may tile the first gel lattice 110. Such tiling is shown in FIG. 9, FIG. 10, FIG. 14, FIG. 15, and FIG. 21.

Though not to be bound by theory, we have observed that a first gel lattice 110 comprising first gaps 130 with a convex pentagon shape that is neither equilateral nor equiangular, with the first gaps 130 arranged in rosettes 360 tiling the first gel lattice 110, are relatively firm while providing improved pressure relief relative to first gaps 130 with hexagonal shapes.

Accordingly, in one embodiment of the first gel lattice 110, all the first gaps 130 have an identical shape selected from diamonds and convex pentagons that is neither equilateral nor equiangular.

Although FIG. 1A and FIG. 1B depict all first gaps 130 as having the same square shape, in other embodiments, the plurality of first gaps 130 may comprise gaps 130 of two or more shapes. Generally, one, two, or more shapes may be chosen to give the first gel lattice 110 a tiled appearance (i.e., the gaps 130 substantially fill a top view such as FIG. 1A without overlaps or omitted spaces).

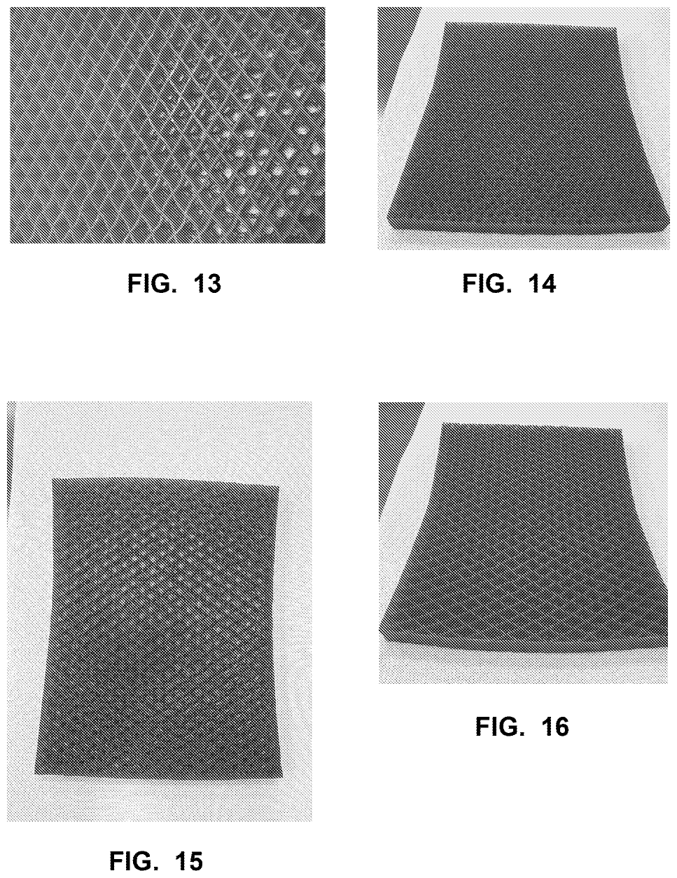

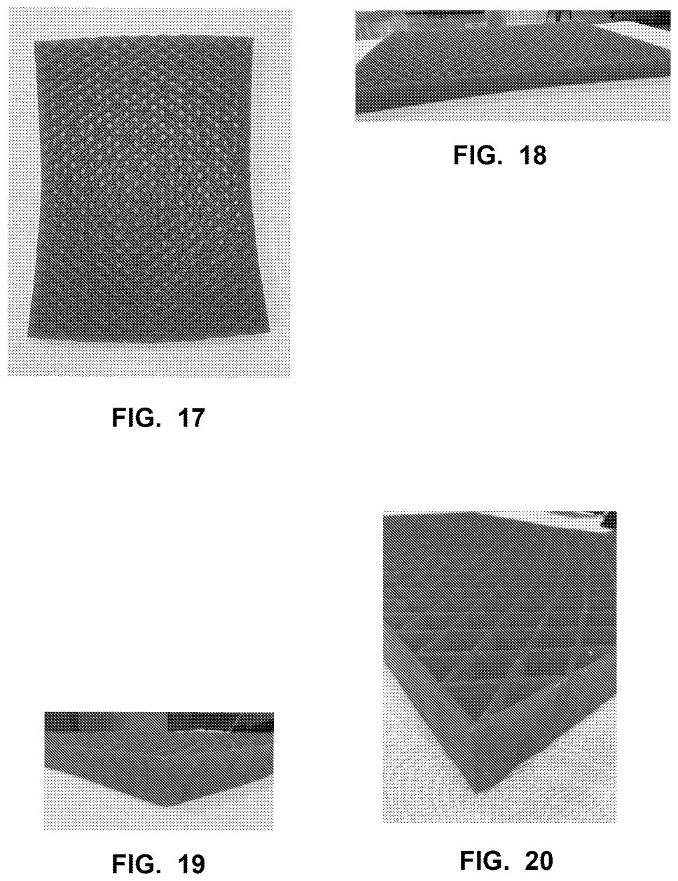

Typically, the one, two, or more shapes may form a single tiling pattern, such as is shown in FIG. 1A and FIG. 9-FIG. 21, but in other embodiments, not shown, the shapes may be varied at different regions of the top surface of the first gel lattice 110.

The person of ordinary skill in the art will bear in mind that referring to the shapes of the first gaps 130 with geometric terms represents an idealization. In practice, the first gaps 130 may essentially or substantially have a given shape, bearing in mind routine processing variations, minimal processing defects, and other factors that will be apparent to the person of ordinary skill in the art having the benefit of the present disclosure. FIG. 9 through FIG. 21 present images of physical instances of gel layers, in which real-world imperfections are apparent, but in which diamond shapes and convex pentagon shapes that are neither equilateral nor equiangular are unequivocally present.

The first gel lattice 110 has a first firmness in a direction parallel to the first gel lattice height, i.e., substantially in the line of sight of the reader looking at FIG. 1A. Though not to be bound by theory, the value of the first firmness may vary depending on one or more of the formulation of the gel in the first gel lattice 110, the height 111 of the first gel lattice, the thickness 121 of the first gel segments 120, and the shape of the first gaps 130, among other structural properties that will be apparent to the person of ordinary skill in the art having the benefit of the present disclosure.

The first firmness does not necessarily have the same value at all points on the top surface of the first gel lattice 110. Variation in shape and size of first gaps 130 in one or more regions of the first gel lattice 110 may be chosen to provide regions of the first gel lattice 110 having slightly greater or slightly lesser firmness than other regions. When we use the term “a firmness” of the first gel lattice 110 or another structure, we refer to a surface-area weighted average of the precise firmness of all regions of the structure.

The gel layer 100 shown in FIG. 1A and FIG. 1B further comprises four first perimeter segments 141, 142, 143, and 144. Each first perimeter segment 141-144 has a first perimeter segment height essentially equal to the first gel lattice height 111, and a first perimeter segment thickness 145 equal to or greater than the first gel segment thickness 121. As can most readily be seen in FIG. 1A, each first perimeter segment 141-144 is essentially coincident with one and only side of the first gel lattice 110 perpendicular to the direction parallel to the first gel lattice height.

Though not to be bound by theory, perimeter segments 141-144 may increase edge strength of the first gel lattice 110, thereby reducing buckling of the first gel lattice 110 around the perimeter and maintaining a desired level of firmness.

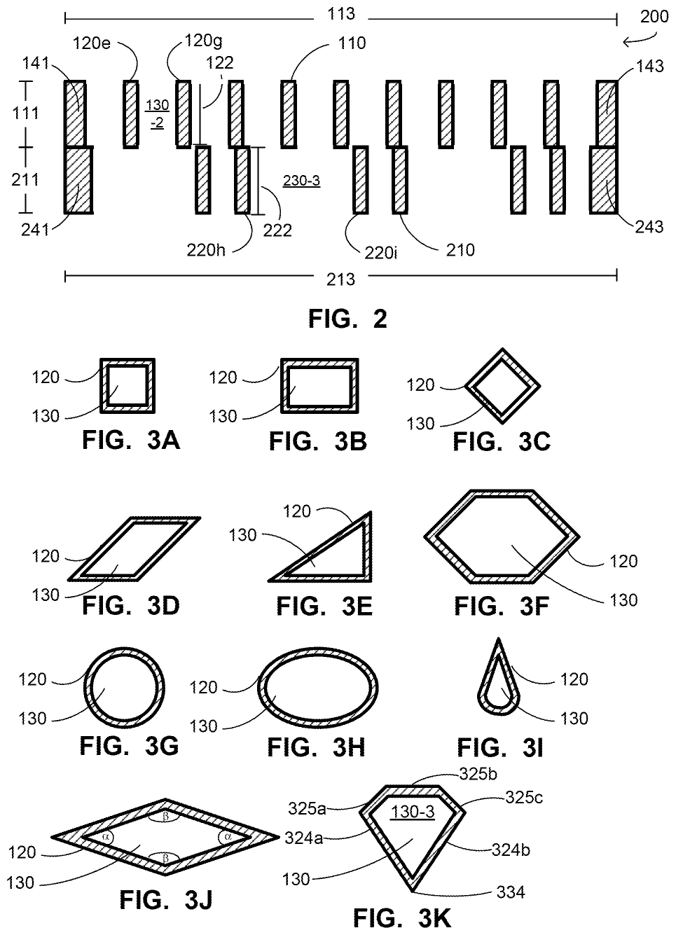

Turning to FIG. 2, a nearsighted side view of a gel layer 200 is shown. FIG. 2 shows numerous elements identical to those shown in FIG. 1A and FIG. 1B. FIG. 2 also shows numerous elements similar to those shown in FIG. 1A and FIG. 1B. Typically, such similar elements will be identified by reference numerals having common ones and tens digits and differing by a “1” or a “2” hundreds digit. For example, FIG. 2 shows the first gel lattice 110 and a second gel lattice 210. The second gel lattice 210 comprises second gel segments 220, similar to first gel segments 120. For the sake of brevity, identical and similar elements will not be described again, and description of elements of FIG. 2 will focus on differences and new aspects relative to those shown and described regarding FIG. 1A and FIG. 1B.

As mentioned above, the gel layer 200 comprises a second gel lattice 210. The second gel lattice 210 may comprise any gel, such as the gel formulation set forth above.

The second gel lattice 210 has a second gel lattice height 211, which may but need not be equal or essentially equal to the first gel lattice height 111. The second gel lattice 210 comprises second gel segments 220, e.g., second gel segments 220h and 220i, which define a plurality of second gaps, e.g., 230-3. The second gaps 230 can be as described above. The second gel lattice 210 has a second firmness in a direction parallel to the second gel lattice height 211.

In one embodiment, the first gel lattice width 112 is essentially equal to the second gel lattice width, and the first gel lattice length 113 is essentially equal to the second gel lattice length 213.

The second gaps 230 may have any shape(s) and size(s) described above. Desirably, the second gaps 230 are generally different in shape(s) and/or size(s) than the first gaps 130. Though not to be bound by theory, different shape(s) and/or size(s) may impart a number of desirable properties to the gel layer 200.

First, the first gel lattice 110 and the second gel lattice 210 will tend to have different firmnesses, such that the firmness of the gel layer 200 perceived by a user will heavily depend on which of the first gel lattice 110 and the second gel lattice 210 is uppermost, i.e., is closest to a user's body when seated or reclined on a body support article comprising the gel layer 200 as an uppermost layer. The gel layer 200 may conveniently provide a choice of firmnesses by arranging one or the other of the first gel lattice 110 and the second gel lattice 210 as an uppermost layer. This may be done in manufacturing or, if the gel layer 200 and a body support article comprising it are so configured, by the user.

A second desirable property is that one or more first spaces 130 may be continuous with one or more second spaces 230. This may allow improved air flow and/or heat dissipation from the user's body, thereby reducing the user's perception of “sleeping hot.”

In a particular embodiment, in the gel layer 200, each of the plurality of first gaps 130 may have a diamond shape; and each of the plurality of second gaps 230 may have a convex pentagon shape that is neither equilateral nor equiangular. The firmness of the first gel lattice 110 may be less than the firmness of the second gel lattice 210.

The gel layer 200 may comprise four layer perimeter segments, each layer perimeter segment having a layer perimeter segment height essentially equal to the sum of the first gel lattice height and the second gel lattice height, and a layer perimeter segment thickness greater than greater of the first gel segment thickness and the second gel segment thickness, with each layer perimeter segment being essentially coincident with the union of one and only side of the first gel lattice perpendicular to the direction parallel to the first gel lattice height and one and only side of the second gel lattice perpendicular to the direction parallel to the second gel lattice height.

In the gel layer 200, all of the first gel lattice 110, the second gel lattice 210, and all lattice and layer perimeter segments may comprise a common gel formulation, such as that described above. In one embodiment, the common gel formulation comprises by weight: Styrene block copolymer 2-80%, plasticized oil 10-90%, thermoplastic polystyrene-polybutadiene-polystyrene block copolymer 5-80%, and green tea oil 0.3%.

Turning to FIG. 4 and FIG. 5, a stylized nearsighted side cross-sectional view of a body support article 400 or 500, in accordance with embodiments herein, is illustrated. The body support article 400 or 500 may have a generally rectangular profile in top view (not shown). For example, the body support article 400 or 500 may be a mattress.

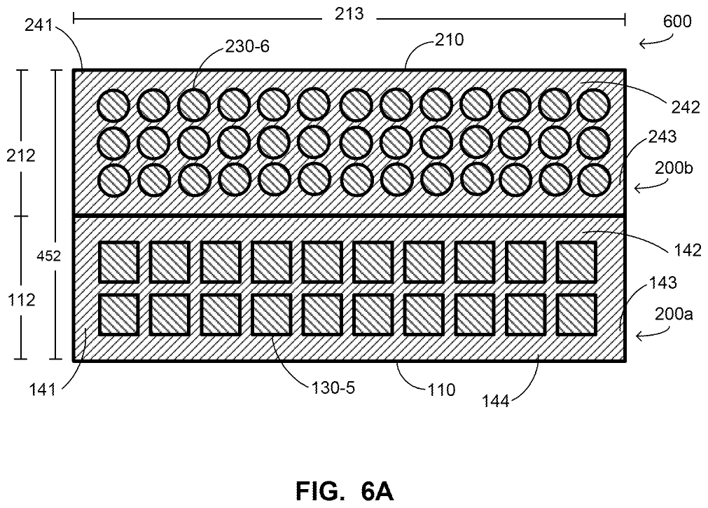

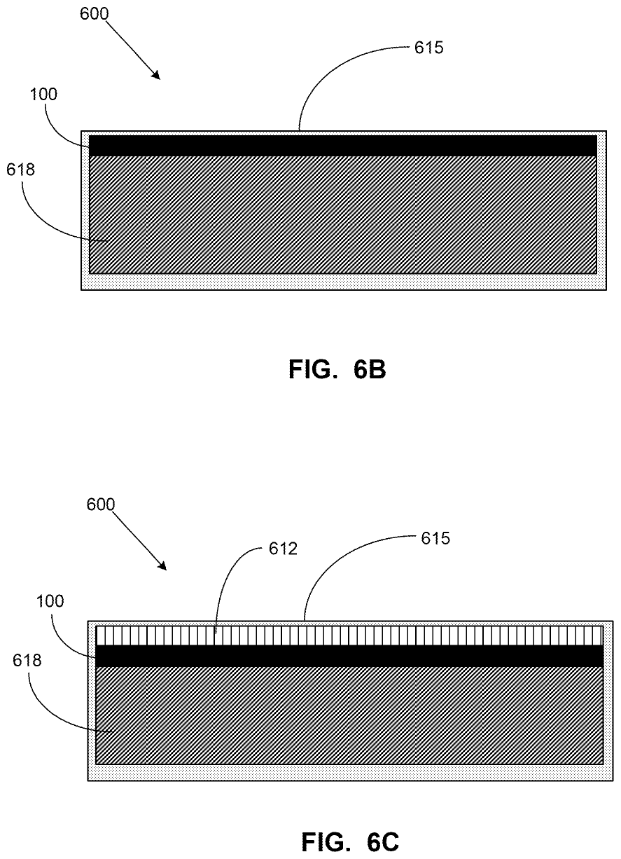

FIG. 6A shows a top view of a body support article 600. FIG. 4-FIG. 6A have much in common and will generally be described together.

As shown in FIG. 4, FIG. 5, and FIG. 6A, the body support article 400 or 500 may comprise a support layer 450 having a rectangular prism shape having a support layer width 452 and a support layer length 453, and gel layer 100 or 200 above the support layer 450.

The support layer 450 may comprise any appropriate material. The material may be a polymeric material, such as polyurethane; a viscoelastic material; a non-viscoelastic material; an elastomeric material; a gel; any material disclosed by any document incorporated herein by reference; or the like.

The gel layer 100 or 200 is as described above.

In one embodiment, as depicted in FIG. 6A, the support layer width 452 is essentially equal to the sum of the first gel lattice width 112 and the second gel lattice width 212, and body support article comprises two instances of the gel layer, e.g., first instance a of gel layer 200 (reference numeral 200a) and second instance b of gel layer 200 (reference numeral 200b), wherein the first instance 200a of the gel layer 200 is positioned on and aligned with a left half of the support layer 450 and a second instance 200b of the gel layer 200 is positioned on and aligned with a right half of the support layer 450. As is customary in the body support article arts, “left” and “right” refer to halves of a top surface of the body support article 600 or a layer thereof as seen by the person of ordinary skill in the art standing at the foot of a piece of furniture comprising the body support article 600. For most body support articles, “left” and “right” are arbitrary, as in either half of the top surface of the body support article may be left or right, unless the body support article is constructed such that one end is intended for supporting a user's head and upper torso and the opposite end is intended for supporting the user's lower legs and feet.

In FIG. 6A, the first instance 200a of the gel layer is positioned with the first gel lattice 110 uppermost. In the first instance 200a, the first spaces 130 have first shapes, e.g., square shapes in the depicted embodiment. The second instance 200b of the gel layer is positioned with the second gel lattice 210 uppermost. In the second instance 200b, the second spaces 230 have second shapes, e.g., circular shapes in the depicted embodiment. Of course, in view of the above discussion of first spaces 130 and second spaces 230, the person of ordinary skill in the art will understand that the first spaces 130 and the second spaces 230 may have any shape.

By having different shapes 130, 230 in their uppermost gel lattices 110, 210, the first instance 200a and the second instance 200b of the gel layer 200 will tend to have different firmnesses as perceived by a user of the body support article 600. Accordingly, if the first member of a couple sharing a bed expresses a preference for a first firmness perceived when the first gel lattice 110 is uppermost, and the second member of the couple expresses a preference for a second firmness perceived when the second gel lattice 210 is uppermost, the particular instance of the gel layer 200 to be positioned on their preferred side of the bed may be oriented such that the gel lattice 110, 210 having their preferred firmness is uppermost. This positioning may be effected during manufacturing, as will be discussed hereinafter, or upon the couple's taking of possession of the body support article 600.

In other embodiments, the body support article 400, 500, or 600 may further comprise at least one layer below the support layer 450.

Alternatively, or in addition, the body support article 400, 500, or 600 may further comprise at least one layer between the support layer 450 and the gel layer 200.

Any layer(s) above or below the support layer 450 may be formed of any appropriate material, such as a polymeric material, such as polyurethane; a viscoelastic material; a non-viscoelastic material; an elastomeric material; a gel; any material disclosed by any document incorporated herein by reference; or the like. The various layers may be bonded together by any suitable adhesive, may be coextruded, or may be fabricated and/or assembled using any process and/or equipment known in the art.

FIG. 22 shows an example of a mattress comprising from top to bottom a gel layer 200 (quilted, uppermost layer), an intervening layer delineated by dark bands, a support layer 450 (with sides presenting wavy diagonal lines), and a base layer.

Turning now simultaneously to FIGS. 6B and 6C, side views of a body support article in accordance with some embodiments herein is illustrated. The body support article 600 may comprise a plurality of inner layers 618. The inner layer 618 depicted in FIGS. 6B and 6C may be representative of a plurality of layers, e.g., foam layers, support member layers, etc.

The inner layers 618 may be encapsulated by a cover layer 615. The cover layer 615 may be comprised of one or more materials, such as cloth material, foam material, etc.

In some embodiments, a gel layer 100 may be positioned above the inner layer 618. The gel layer 100 may then be encapsulated by the cover layer 615. The gel layer 100 may be divided into two regions, wherein a first gel lattice forms the first region of the gel layer 100 and a second gel lattice forms the second region of the gel layer 100. FIG. 6A exemplifies one embodiment of such first and second regions.

In some embodiments, the gel layer 100 may be positioned above the inner layer 618, but below a top layer 612, as shown in FIG. 6C. The top layer 612 may be one or a variety of types of layer, such as foam layer, support member layer, etc.

Further, in one embodiment, the split between the first and second regions of the gel layer 100 may be the center of the layer, wherein the first region may be the left side of the gel layer 100 and the second region may be the right side of the gel layer 100. The first region may express a first firmness while the second region may express a second firmness. In this manner, the gel layer 100 allows for a dual firmness expression for a body support article.

In alternative embodiments, the division between first and second regions of the gel layer 100 may not be the center of the gel layer 100. That is, the first region may occupy a greater than 50% of the total space of the gel layer 100, while the second region occupies less than 50% of the total gel layer 100, e.g., a 60%-40% split between the first and second regions of the gel layer 100, respectively. In some embodiments, the configuration of the first and second regions of the gel layer 100 may be customized based on consumer inputs, such as answers to questionnaire regarding customer preferences as to cooling, firmness, etc. of the body support article.

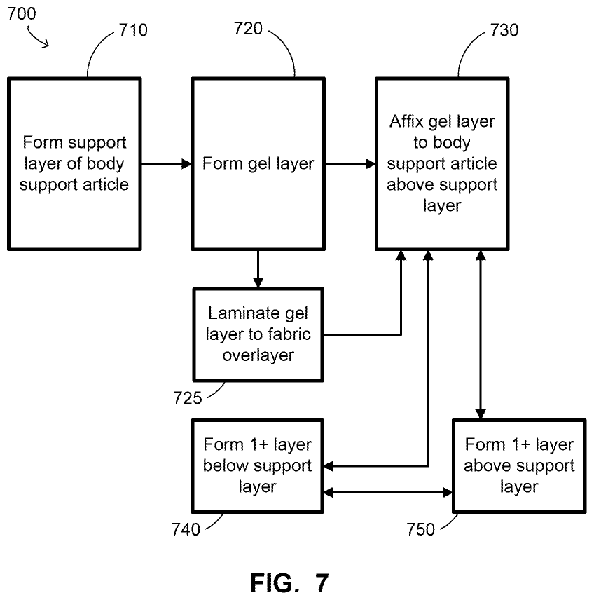

Turning to FIG. 7, a flowchart of a method 700 is shown. The method 700 comprises forming (at 710) a support layer of a body support article, the support layer having a rectangular prism shape having a support layer width and a support layer length.

The body support article and the support layer may be as described above. Starting materials, techniques, and apparatus for forming (at 710) the support layer may depend on the final materials of the formed support layer, other layers to be produced simultaneously with, before, and/or after forming (at 710) the support layer, how other layers are to be combined into a final body support article, and considerations of cost and/or process efficiency, among other factors that will be apparent to the person of ordinary skill in the art having the benefit of the present disclosure.

The method 700 also comprises forming (at 720) a gel layer comprising a first gel lattice having a rectangular prism shape having a first gel lattice height, a first gel lattice width, and a first gel lattice length, wherein the first gel lattice height is no more than one-third of the shorter of the first gel lattice width and the first gel lattice length, the first gel lattice width is less than or equal to the support layer width, and the first gel lattice length is less than or equal to the support layer length, the first gel lattice comprising a plurality of first gel segments each having a first segment height essentially equal to the first gel lattice height and a first segment thickness less than the first segment height, wherein the first gel segments define a plurality of first gaps, and the first gel lattice has a first firmness in a direction parallel to the first gel lattice height.

Generally, the gel layer may be as described above. Starting materials, techniques, and apparatus for forming (at 720) the gel layer may depend on the formulation of the formed gel layer, other layers to be produced simultaneously with, before, and/or after forming (at 720) the gel layer and/or at later steps of the method 700, how other layers are to be combined into a final body support article, and considerations of cost and/or process efficiency, among other factors that will be apparent to the person of ordinary skill in the art having the benefit of the present disclosure.

In one embodiment, the gel layer may be formed (at 720) by injection molding, wherein a liquid formulation is introduced into a mold that is a three-dimensional negative of the gel layer, the liquid formulation gels to yield the gel layer inside the mold, and the mold is removed to yield the gel layer in a form usable for subsequent elements of the method 700. Selection of process conditions, apparatus, and techniques for injection molding will be a routine matter for the person of ordinary skill in the art having the benefit of the present disclosure.

The method 700 further comprises affixing (at 730) the gel layer to the body support article above the support layer. Affixing (at 730) may comprise any known techniques, such as gluing, bonding, laminating, co-extruding, stitching, etc.

In a particular embodiment, the method 700 may further comprise laminating (at 725) the gel layer to a fabric overlayer. The fabric overlayer may comprise any fabric known for use in upholstering mattresses or other body support articles, such as a cotton, a linen, a silk, a burlap, a canvas, a wool, a jute, a sisal, a synthetic fabric, etc. In one embodiment, the fabric overlayer comprises cotton with a thread count of 500 or more, such as 800 or more or 1000 or more. Laminating the gel layer to the fabric will involve the selection of optimum process conditions and other parameters that will be arrived at through routine experimentation by the person of ordinary skill in the art having the benefit of the present disclosure.

In embodiments wherein laminating (at 725) is performed, the affixing (at 730) may comprise stitching the fabric overlayer to the body support article. Stitching may be facilitated by the presence of a plurality of channels extending from the top to the bottom of the gel layer, such channels being coincident with first spaces 130 (in a gel layer such as gel layer 100) or being formed where first spaces 130 and second spaces 230 are vertically aligned (in a gel layer such as gel layer 200). Such channels are conceptually depicted in FIG. 1B, FIG. 2, and FIG. 4-FIG. 6A, and are visible in images of physically extant gel layers, e.g., FIG. 9-FIG. 13. Stitching may yield an esthetically pleasing quilted aspect to the fabric overlayer and the gel layer, such as is shown in FIG. 22.

The method 700 may comprise numerous variations to form body support articles comprising a gel layer above a support layer having particular properties that may be desirable. In one embodiment, forming (at 710) the support layer may comprise forming the support layer to have a width essentially equal to the sum of the first gel lattice width and the second gel lattice width, forming (at 720) may comprise forming two instances of the gel layer, wherein, and affixing (at 730) may comprise positioning a first instance of the gel layer on and aligned with a left half of the support layer and positioning a second instance of the gel layer on and aligned with a right half of the support layer. In a particular further embodiment, forming (at 720) the first instance of the gel layer and the second instance of the gel layer may comprise forming an uppermost gel lattice of the first instance of the gel layer to have a firmness different from a firmness of an uppermost gel lattice of the second instance of the gel layer.

Alternatively, or in addition, the method 700 may further comprise forming (at 740) at least one layer below the support layer. Alternatively, or in addition, the method 700 may further comprise forming (at 750) at least one layer between the support layer and the gel layer. The at least one layer below the support layer and the at least one layer between the support layer and the gel layer may be as described above. The person of ordinary skill in the art having the benefit of the present disclosure will readily be able to form such layers (at 740 and/or 750) using known apparatus, process conditions, and techniques).

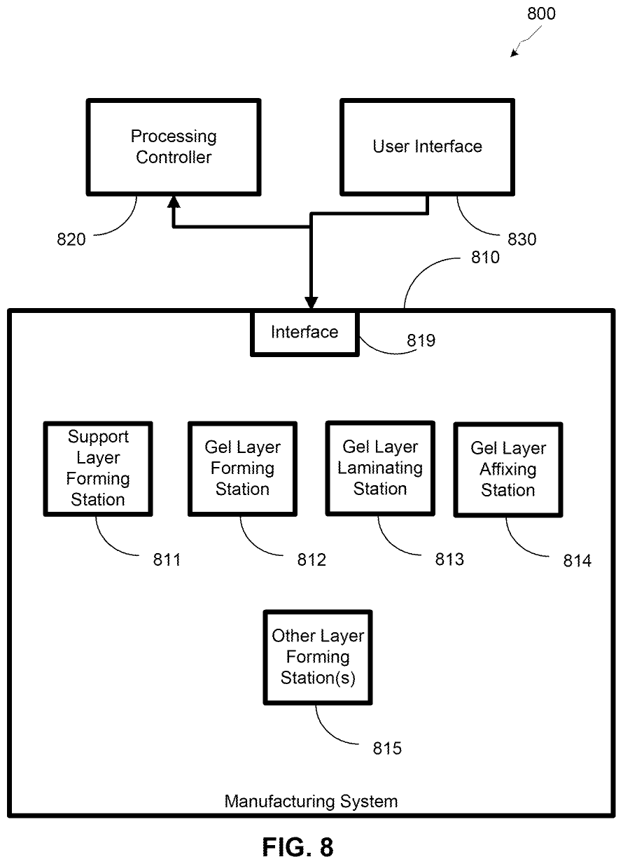

We turn now to FIG. 8, which provides a block diagram of a system 800.

Turning now to FIG. 8, a stylized depiction of a system 800 for fabricating a body support article in accordance with embodiments herein is illustrated. The system 800 of FIG. 8 may comprise a manufacturing system 810, a processing controller 820, and a user interface 830. The manufacturing system 810 may manufacture body support articles based upon one or more designs generated and/or provided by processing controller 820 and input received from the user interface 830.

The manufacturing system 810 may comprise various processing stations, such as support layer forming station 811, gel layer forming station 812, gel layer laminating station 813, gel layer affixing station 814, other layer forming station(s) 815, material handling stations, final product handling stations, etc. Each of the processing stations may comprise one or more appropriate apparatus, input conveyances, output conveyances, utility subsystems (e.g., water, electricity, heat, steam, coolant, etc.), local controls, sensors or other process data gathering devices, communications with other processing stations, the processing controller 820, the user interface 830, etc. The operations to be performed at each station 811-815 may be those described above regarding corresponding operations performed in the method 700.

The manufacturing system 810 may also comprise an interface 819 that is capable of providing communications between two or more of one, some, or all processing stations 811-815, the processing controller 820, and the user interface 830. One or more of the processing steps performed by the manufacturing system 810 may be controlled by the processing controller 820. The processing controller 820 may be a workstation computer, a desktop computer, a laptop computer, a tablet computer, or any other type of computing device comprising one or more software products that are capable of controlling processes, which may comprise receiving process feedback, receiving test results data, performing learning cycle adjustments, performing process adjustments, etc.

The user interface 830 may be configured to receive any desired input from one or more users. The user(s) may be manufacturing worker(s) and/or consumer(s). In one embodiment, the input is a first user preference between at least a first firmness and a second firmness. The user interface 830 may be instantiated in hardware or software at a location remote from the manufacturing system 810. For example, the user interface 830 may be instantiated as an app on a computer or smartphone; a webpage accessible via a browser; a kiosk deployed at a point-of-sale location (e.g., a mattress retailer) and comprising a touchscreen and/or physical buttons for user input and a display, such as a graphical display, for presenting options and instructions to the user; etc.

In one embodiment, the user interface 830 may be further configured to receive a second user preference between at least the first firmness and the second firmness.

In a particular embodiment, the manufacturing system 810 may be configured to: form a support layer of a body support article, the support layer having a rectangular prism shape having a support layer width and a support layer length; form a first instance of a gel layer comprising a first gel lattice having a rectangular prism shape having a first gel lattice height, a first gel lattice width, and a first gel lattice length, wherein the first gel lattice height is no more than one-third of the shorter of the first gel lattice width and the first gel lattice length, the first gel lattice width is less than or equal to the support layer width, and the first gel lattice length is less than or equal to the support layer length, the first gel lattice comprising a plurality of first gel segments each having a first segment height essentially equal to the first gel lattice height and a first segment thickness less than the first segment height, wherein the first gel segments define a plurality of first gaps, and a firmness of the first instance of the gel layer in a first direction parallel to the first gel lattice height is essentially equal to the first firmness; form a second instance of the gel layer, wherein the firmness of the second instance of the gel layer in the first direction is essentially equal to the second firmness; affix the first instance of the gel layer to the body support article above the support layer, in response to the first user preference being for the first firmness; and affix the second instance of the gel layer to the body support article above the support layer, in response to the first user preference being for the second firmness.

In a further embodiment, wherein the user interface 830 is further configured to receive a second user preference between at least the first firmness and the second firmness, the manufacturing system 810 may be further configured to form the first instance of the gel layer and the second instance of the gel layer to each have a width equal to approximately half the width of the support layer, affix the one of the first instance and the second instance having essentially the firmness preferred by the first user to a first half of a top of the body support article; and affix the other of the first instance or the second instance to a second half of the top of the body support article, wherein the other instance has essentially the firmness preferred by the second user.

For the avoidance of doubt, the first user's preferred firmness could be the same as the second user's preferred firmness but need not be.

Further, generally, any structures shown and described in one embodiment of the present disclosure may be incorporated into any other embodiment of the present disclosure, regardless of whether such structures are explicitly described as being components of that other embodiment.

A body support article of any disclosed embodiment may be positioned on any appropriate foundation disposed thereunder. For example, if the body support article is a mattress, the foundation may be selected from, but is not limited to, box springs; metal frames; and adjustable supports, including electromechanically adjustable supports; among others.

The particular embodiments disclosed above are illustrative only, as the disclosure may be modified and practiced in different, but equivalent manners, apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. A gel layer, comprising:
a first gel lattice having a first geometric shape, the first geometric shape having:
a first gel lattice height;
a first gel lattice width; and
a first gel lattice length;
wherein the first gel lattice comprises a plurality of first gel segments, wherein the first gel segments define a plurality of first gaps, and the first gel lattice has a first firmness.

2. The gel layer of claim 1, wherein the first geometric shape is a rectangular prism shape.

3. The gel layer of claim 1, wherein the first gel lattice height is no more than one-third of the shorter of the first gel lattice width and the first gel lattice length, the first gel lattice comprising a plurality of first gel segments each having a first segment height essentially equal to the first gel lattice height and a first segment thickness less than the first segment height, and wherein the first firmness is in a direction parallel to the first gel lattice height.

4. The gel layer of claim 6, wherein the essential oil additive is green tea oil at 0.3%.

5. The gel layer of claim 1, further comprising four first perimeter segments, each first perimeter segment having a first perimeter segment height essentially equal to the first gel lattice height and a first perimeter segment thickness equal to or greater than the first gel segment thickness, with each first perimeter segment being essentially coincident with one and only side of the first gel lattice perpendicular to the direction parallel to the first gel lattice height.

6. The gel layer of claim 1, wherein the gel layer is configured to be inserted into a body support article.

7. The gel layer of claim 6, wherein the body support article may be at least one of: a mattress, a mattress topping, a cushion

8. The gel layer of claim 1, further comprising:
a second gel lattice having a second geometric shape, the second geometric shape having:
a having a second gel lattice height;
a second gel lattice width; and
a second gel lattice length;
wherein the second gel lattice comprises a plurality of second gel segments, wherein the second gel segments define a plurality of second gaps, and the second gel lattice has a second firmness.

9. The gel layer of claim 8, wherein the second geometric shape is a rectangular prism shape.

10. The gel layer of claim 9, wherein the second gel lattice height is no more than one-third of the shorter of the second gel lattice width and the second gel lattice length, the second gel lattice comprising a plurality of second gel segments each having a second segment height essentially equal to the second gel lattice height and a second segment thickness less than the second segment height, wherein the second gel segments define a plurality of second gaps, and the second gel lattice has a second firmness in a direction parallel to the second gel lattice height.

11. The gel layer of claim 8, wherein the first gel lattice width is essentially equal to the second gel lattice width and the first gel lattice length is essentially equal to the second gel lattice length; and wherein the first gel lattice height is essentially equal to the second gel lattice height.

12. The gel layer of claim 8, wherein each of the plurality of the first gaps and the second gaps has a second size and a second shape selected from the group consisting of squares, rectangles, diamonds, parallelograms, other quadrilaterals, triangles, polygons with other than four sides, circles, ellipses, raindrops, and other curved shapes.

13. The gel layer of claim 12, wherein each of the plurality of the first gaps and the second gaps has a diamond shape or a convex pentagon shape that is neither equilateral nor equiangular.

14. The gel layer of claim 8, wherein each of the first gel lattice and the second gel lattice comprises by weight: Styrene block copolymer 2-80%, plasticized oil 10-90%, thermoplastic polystyrene-polybutadiene-polystyrene block copolymer 5-80%, and essential oil additive 0.01%-3%.

15. The gel layer of claim 8, further comprising four second perimeter segments, each second perimeter segment having a second perimeter segment height essentially equal to the second gel lattice height and a second perimeter segment thickness equal to or greater than the second gel segment thickness, with each second perimeter segment being essentially coincident with one and only side of the second gel lattice perpendicular to the direction parallel to the second gel lattice height.

16. The gel layer of claim 8, wherein:
each of the plurality of first gaps has a diamond shape; and
the gel layer further comprises:
(a) a second gel lattice having a rectangular prism shape having a second gel lattice height, a second gel lattice width, and second gel lattice a length, wherein the second gel lattice height is no more than one-third of the shorter of the second gel lattice width and the second gel lattice length, the second gel lattice comprising a plurality of second gel segments each having a second segment height essentially equal to the second gel lattice height and a second segment thickness less than the second segment height, wherein the second gel segments define a plurality of second gaps, and the second gel lattice has a second firmness in a direction parallel to the second gel lattice height,
wherein each of the plurality of second gaps has a convex pentagon shape that is neither equilateral nor equiangular, the first gel lattice width is essentially equal to the second gel lattice width, the first gel lattice length is essentially equal to the second gel lattice length, the first gel lattice height is essentially equal to the second gel lattice height, and the firmness of the first gel lattice is less than the firmness of the second gel lattice; and
(b) four layer perimeter segments, each layer perimeter segment having a layer perimeter segment height essentially equal to the sum of the first gel lattice height and the second gel lattice height, and a layer perimeter segment thickness greater than greater of the first gel segment thickness and the second gel segment thickness, with each layer perimeter segment being essentially coincident with the union of one and only side of the first gel lattice perpendicular to the direction parallel to the first gel lattice height and one and only side of the second gel lattice perpendicular to the direction parallel to the second gel lattice height;
wherein the first gel lattice, the second gel lattice, and the four layer perimeter segments comprise a common gel formulation, wherein the common gel formulation comprises by weight: Styrene block copolymer 2-80%, plasticized oil 10-90%, thermoplastic polystyrene-polybutadiene-polystyrene block copolymer 5-80%, and green tea oil 0.3%.

17. A gel layer, comprising:
a first gel lattice having a first geometric shape, the first geometric shape having:
a first gel lattice height;
a first gel lattice width; and
a first gel lattice length;
and
a second gel lattice having a second geometric shape, the second geometric shape having:
a second gel lattice height;
a second gel lattice width; and
a second gel lattice length;
wherein the first gel lattice comprises a plurality of first gel segments, wherein the first gel segments define a plurality of first gaps, and the first gel lattice has a first firmness;
wherein the second gel lattice comprises a plurality of second gel segments, wherein the second gel segments define a plurality of second gaps, and the second gel lattice has a second firmness; and
wherein the gel layer is configured to be inserted into a body support article.

18. The gel layer of claim 17, wherein:
wherein the first gel lattice height is no more than one-third of the shorter of the first gel lattice width and the first gel lattice length, the first gel lattice comprising a plurality of first gel segments each having a first segment height essentially equal to the first gel lattice height and a first segment thickness less than the first segment height, wherein the first gel segments define a plurality of first gaps, and wherein the first firmness is in a direction parallel to the first gel lattice height; and
the second gel lattice height is no more than one-third of the shorter of the second gel lattice width and the second gel lattice length, the second gel lattice comprising a plurality of second gel segments each having a second segment height essentially equal to the second gel lattice height and a second segment thickness less than the second segment height, wherein the second gel segments define a plurality of second gaps, and wherein second firmness in a direction parallel to the second gel lattice height.

19. A gel layer, comprising:
a first gel lattice having a rectangular prism shape having a first gel lattice height, a first gel lattice width, and a first gel lattice length, wherein the first gel lattice height is no more than one-third of the shorter of the first gel lattice width and the first gel lattice length, the first gel lattice comprising a plurality of first gel segments each having a first segment height essentially equal to the first gel lattice height and a first segment thickness less than the first segment height, wherein the first gel segments define a plurality of first gaps, and the first gel lattice has a first firmness in a direction parallel to the first gel lattice height; and
a second gel lattice having a rectangular prism shape having a second gel lattice height, a second gel lattice width, and second gel lattice a length, wherein the second gel lattice height is no more than one-third of the shorter of the second gel lattice width and the second gel lattice length, the second gel lattice comprising a plurality of second gel segments each having a second segment height essentially equal to the second gel lattice height and a second segment thickness less than the second segment height, wherein the second gel segments define a plurality of second gaps, and the second gel lattice has a second firmness in a direction parallel to the second gel lattice height.

20. The gel layer of claim 19, wherein:
each of the plurality of first gaps has a diamond shape; and
the gel layer further comprises:
(a) a second gel lattice having a rectangular prism shape having a second gel lattice height, a second gel lattice width, and second gel lattice a length, wherein the second gel lattice height is no more than one-third of the shorter of the second gel lattice width and the second gel lattice length, the second gel lattice comprising a plurality of second gel segments each having a second segment height essentially equal to the second gel lattice height and a second segment thickness less than the second segment height, wherein the second gel segments define a plurality of second gaps, and the second gel lattice has a second firmness in a direction parallel to the second gel lattice height,
wherein each of the plurality of second gaps has a convex pentagon shape that is neither equilateral nor equiangular, the first gel lattice width is essentially equal to the second gel lattice width, the first gel lattice length is essentially equal to the second gel lattice length, the first gel lattice height is essentially equal to the second gel lattice height, and the firmness of the first gel lattice is less than the firmness of the second gel lattice; and
(b) four layer perimeter segments, each layer perimeter segment having a layer perimeter segment height essentially equal to the sum of the first gel lattice height and the second gel lattice height, and a layer perimeter segment thickness greater than greater of the first gel segment thickness and the second gel segment thickness, with each layer perimeter segment being essentially coincident with the union of one and only side of the first gel lattice perpendicular to the direction parallel to the first gel lattice height and one and only side of the second gel lattice perpendicular to the direction parallel to the second gel lattice height;
wherein the first gel lattice, the second gel lattice, and the four layer perimeter segments comprise a common gel formulation, wherein the common gel formulation comprises by weight: Styrene block copolymer 2-80%, plasticized oil 10-90%, thermoplastic polystyrene-polybutadiene-polystyrene block copolymer 5-80%, and green tea oil 0.3%.
